(19) United States
(12) Patent Application Publication
(10) Pub. No.: US 2025/0341654 A1
(43) Pub. Date: Nov. 6, 2025

(54) COUPLING NATURAL FRACTURE NETWORK TO A SINGLE MEDIA FOR RESERVOIR NUMERICAL SIMULATION

(71) Applicant: Saudi Arabian Oil Company, Dhahran (SA)

(72) Inventors: Karla Olvera Carranza, Dhahran (SA); Otto Meza Camargo, Dhahran (SA); Francisco Pinto Garcia, Dhahran (SA)

(21) Appl. No.: 18/655,797

(22) Filed: May 6, 2024

(51) Int. Cl. G01V 20/00; E21B 44/00

(52) U.S. Cl. CPC G01V 20/00; E21B 44/00; E21B 2200/20

(57) ABSTRACT

Modeling natural fractures of a formation having a hydrocarbon reservoir by representing a discrete natural fracture network as a continuous property and dynamically calibrating the discrete natural fracture network for coupling into a single media for reservoir numerical simulation. A mechanical earth model and fracture model having a fracture density index for a naturally fractured reservoir may be determined. A static calibration and a dynamic calibration may be performed for the discrete natural fracture network. A history match of flow rate and bottom-hole pressure may also be performed.

### BACKGROUND

### Field of the Disclosure

The present disclosure generally relates to developing hydrocarbon reservoirs. More specifically, embodiments of the disclosure relate to locating and drilling wells based on assessment and modeling of natural fractures in hydrocarbon reservoir.

### Description of the Related Art

A rock formation that resides under the Earth's surface is often referred to as a “subsurface” formation. A subsurface formation that contains a subsurface pool of hydrocarbons, such as oil and gas, is often referred to as a “hydrocarbon reservoir.” Hydrocarbons are typically extracted (or “produced”) from a hydrocarbon reservoir by way of a hydrocarbon well. A hydrocarbon well normally includes a wellbore (or “borehole”) that is drilled into the reservoir. The extraction of hydrocarbon resources from reservoirs in rock formations may depend on a variety of factors. Some reservoirs may present particular challenges with respect to hydraulic fracturing and identifying suitable intervals for fracturing. Naturally fractured reservoirs may present such challenges.

### SUMMARY

Natural fractures are a key element for reservoir characterization and numerical simulation processes due to their critical role as fluid-flow pathways and their influence on reservoir fluid-flow and dynamic performance during field development. However, reliability constructing a model of natural fractures is difficult; such a model depends on the integration of several multi-disciplinary and comprehensive inputs such as well-scale fracture characterization, a 3D deformation model, a 3D mechanical earth model and fracture modeling processes.

In one embodiment, a method for developing a hydrocarbon reservoir is provided. The method includes forming, using a mechanical earth model, a fracture network model to identify the presence and extent of natural fractures at locations in the subsurface hydrocarbon reservoir, such that the mechanical earth model incorporates the principal stress. The method also includes determining, using the discrete fracture network, a fracture density index (FDI), such that determining the fracture density index (FDI) includes generating a raster map from the discrete fracture network, the raster map representing a fracture density per area. Additionally, the method includes modifying the fracture density index (FDI) based on a flow capacity response, calibrating the modified fracture density index (FDI) using a bottom hole pressure (BHP) and a BHP rate, and applying the calibrated modified fracture density index (FDI) to a single media matrix permeability for the reservoir to determine an improved matrix permeability.

In some embodiments, the flow capacity response includes a flow capacity from a pressure transient analysis (PTA). In some embodiments, the flow capacity response includes a flow capacity from a matrix permeability model. In some embodiments, calibrating the modified fracture density index (FDI) using a bottom hole pressure (BHP) and a BHP rate includes using a pressure transient analysis simulation to determine a permeability multiplier. In some embodiments, the method includes performing a history match between for the bottom hole pressure (BHP). In some embodiments, the modified fracture density index (FDI) includes an effective permeability tensor. In some embodiments, the method includes determining a location for a well to access the hydrocarbon reservoir using the improved matrix permeability. In some embodiments, the method includes drilling the well at the location to access the hydrocarbon reservoir.

In another embodiment, a non-transitory computer-readable storage medium having executable code stored thereon for developing a hydrocarbon reservoir is provided. The executable code includes a set of instructions that causes a processor to perform operations that include forming, using a mechanical earth model, a fracture network model to identify the presence and extent of natural fractures at locations in the subsurface hydrocarbon reservoir, such that the mechanical earth model incorporates the principal stress. The operations also include determining, using the discrete fracture network, a fracture density index (FDI), such that determining the fracture density index (FDI) includes generating a raster map from the discrete fracture network, the raster map representing a fracture density per area. Additionally, the operations include modifying the fracture density index (FDI) based on a flow capacity response, calibrating the modified fracture density index (FDI) using a bottom hole pressure (BHP) and a BHP rate, and applying the calibrated modified fracture density index (FDI) to a single media matrix permeability for the reservoir to determine an improved matrix permeability.

In some embodiments, the flow capacity response includes a flow capacity from a pressure transient analysis (PTA). In some embodiments, the flow capacity response includes a flow capacity from a matrix permeability model. In some embodiments, calibrating the modified fracture density index (FDI) using a bottom hole pressure (BHP) and a BHP rate includes using a pressure transient analysis simulation to determine a permeability multiplier. In some embodiments, the operations include performing a history match between for the bottom hole pressure (BHP). In some embodiments, the modified fracture density index (FDI) includes an effective permeability tensor. In some embodiments, the operations include determining a location for a well to access the hydrocarbon reservoir using the improved matrix permeability. In some embodiments, the operations include controlling a drilling operation to drill the well at the location to access the hydrocarbon reservoir.

In another embodiment, a system for developing a hydrocarbon reservoir is provided. The system includes a processor and a non-transitory computer-readable memory accessible by the processor and having executable code stored thereon. The executable code includes a set of instructions that causes a processor to perform operations that include forming, using a mechanical earth model, a fracture network model to identify the presence and extent of natural fractures at locations in the subsurface hydrocarbon reservoir, such that the mechanical earth model incorporates the principal stress. The operations also include determining, using the discrete fracture network, a fracture density index (FDI), such that determining the fracture density index (FDI) includes generating a raster map from the discrete fracture network, the raster map representing a fracture density per area. Additionally, the operations include modifying the fracture density index (FDI) based on a flow capacity response, calibrating the modified fracture density index (FDI) using a bottom hole pressure (BHP) and a BHP rate, and applying the calibrated modified fracture density index (FDI) to a single media matrix permeability for the reservoir to determine an improved matrix permeability.

In some embodiments, the flow capacity response includes a flow capacity from a pressure transient analysis (PTA). In some embodiments, the flow capacity response includes a flow capacity from a matrix permeability model. In some embodiments, calibrating the modified fracture density index (FDI) using a bottom hole pressure (BHP) and a BHP rate includes using a pressure transient analysis simulation to determine a permeability multiplier. In some embodiments, the operations include performing a history match between for the bottom hole pressure (BHP). In some embodiments, the modified fracture density index (FDI) includes an effective permeability tensor. In some embodiments, the operations include determining a location for a well to access the hydrocarbon reservoir using the improved matrix permeability. In some embodiments, the operations include controlling a drilling operation to drill the well at the location to access the hydrocarbon reservoir.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts a process for coupling a natural fracture network to a single media for reservoir numerical simulation in accordance with an embodiment of the disclosure;

FIG. 2 depicts the gridding of a 3D mechanical earth model in accordance with an embodiment of the disclosure;

FIG. 3 depicts a plot of true vertical depth vs. vertical stress gradient that shows a vertical stress calculation using a compaction line and bulk density in accordance with an embodiment of the disclosure;

FIG. 4 is a composite log showing gamma ray (Gr) measurements, lithology, and fracture closure pressure, minimum horizontal stress (Sₕₘᵢₙ), vertical stress (Sᵥ), maximum horizontal stress (Sₕₘₐₓ), and pore pressure, in accordance with an embodiment of the disclosure;

FIG. 5A is a diagram illustrating fluid flow paths for hydraulically conductive and non-hydraulically conductive fractures using normal stresses (σ₁ and σ₃) in accordance with an embodiment of the disclosure;

FIG. 5B is a plot of shear stress vs normal stress and coefficient of friction in accordance with an embodiment of the disclosure;

FIG. 6A depicts a 2D fracture network illustrating main fluid pathways in an area in accordance with an embodiment of the disclosure;

FIG. 6B depicts a line density raster map computed from the 2D fracture network of FIG. 6A in accordance with an embodiment of the disclosure.

FIG. 7A depicts a graph of normal stress v. normal displacement (on) in accordance with an embodiment of the disclosure;

FIG. 7B depicts a graph of dilation vs shear displacement (δₙ), in accordance with an embodiment of the disclosure;

FIG. 8 depicts a workflow of multiple fracture realizations that may be used for validations and calibrations in accordance with an embodiment of the disclosure;

FIG. 9A depicts a stress diagram using normal stresses (σ₁ and σ₃) in accordance with an embodiment of the disclosure;

FIG. 9B is a plot of shear stress vs normal stress and coefficient of friction and depicts a Mohr diagram in accordance with an embodiment of the disclosure;

FIGS. 10A-10C depict fracture porosity and effective tensor permeability calculated from a scale up process in accordance with an embodiment of the disclosure;

FIG. 11A depicts a plot of KHₘₐₜᵣᵢₓ vs a KHₚₜₐ using a matrix calibration in accordance with an embodiment of the disclosure;

FIG. 11B depicts a plot of KHₜₒₜₐₗ (KHₘₐₜᵣᵢₓ+KH_{fracture}) VS. KHₚₜₐ using a matrix +fracture KH calibration in accordance with an embodiment of the disclosure;

FIG. 12 depicts PTA flow capacity (KHₚₜₐ) overlaid on a fracture density index map in accordance with an embodiment of the disclosure;

FIG. 13 depicts a process for dynamic calibration in accordance with an embodiment of the disclosure;

FIGS. 14A and 14B show a comparison of KH calibration results for single porosity/single permeability (SPSP) and SPSP+fracture density index (FDI) in accordance with an embodiment of the disclosure;

FIG. 15A depicts a fracture density index map with the fracture density index values identified by the color legend in accordance with an embodiment of the disclosure;

FIG. 15B depicts a KH value map with the KH value identified by the color legend 1506 in accordance with an embodiment of the disclosure;

FIG. 15C depicts a KH value map after the application of the fracture density index as a matrix permeability enhancer to the KH value map of FIG. 15B in accordance with an embodiment of the disclosure;

FIG. 16 is a plot of pressure vs. time showing the pressure match profile for SPSP and SPSP+FDI scenarios in accordance with an embodiment of the disclosure;

FIG. 17 is a schematic diagram that illustrates a well environment for implementing embodiments of the disclosure; and

FIG. 18 is a block diagram of a data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to modeling natural fractures of a formation having a hydrocarbon reservoir by representing a discrete natural fracture network as a continuous property and dynamically calibrating the discrete natural fracture network for coupling into a single media for reservoir numerical simulation. The reservoir simulation may be used to identify regions of interest and determine locations for drilling wells to access the hydrocarbon reservoir, such further operations such as well completion or hydraulic fracturing.

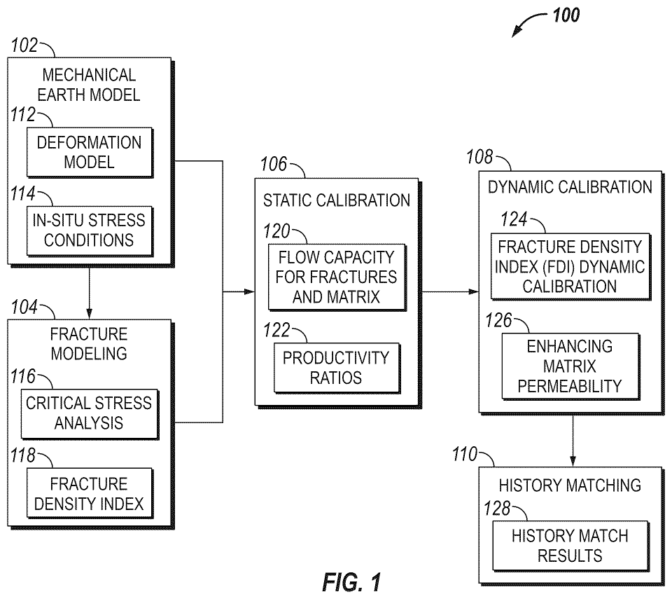

FIG. 1 depicts a process 100 for coupling a natural fracture network to a single media for reservoir numerical simulation in accordance with an embodiment of the disclosure. A shown in FIG. 1, the process includes determining a mechanical earth model (block 102), performing fracture modeling (block 104), performing a static calibration (block 106), performing a dynamic calibration (block 108), and performing history matching (block 110).

The process 100 may initially include determining a mechanical earth model (block 102), such as a 1D/3D mechanical earth model. In some embodiments, the mechanical earth model may be implemented according to the techniques described in U.S. Pat. No. 11,098,582, issued Aug. 24, 2021, and titled “DETERMINATION OF CALIBRATED MINIMUM HORIZONTAL STRESS MAGNITUDE USING FRACTURE CLOSURE PRESSURE AND MULTIPLE MECHANICAL EARTH MODEL REALIZATIONS,” now issued U.S. Pat. No. 11,098,582, a copy of which is incorporated by reference in its entirety.

As shown in FIG. 1, determining the mechanical earth model (block 102) may include determining a deformation model (block 112) for paleo reconstruction and determining in-situ stress conditions (block 114). The deformation model and in-situ stress modeling may be provided as inputs to a discrete fracture network that defines the spatial distribution and fracture parameters such as length, orientation, aspect ratio (length/height), aperture and fracture permeability.

Determining the deformation model (block 112) may include performing a geomechanics numerical simulation using finite element techniques to capture the main episodes of paleo-stress tectonic deformation that could create most of the fracture observed at well level. These fractures may be modeled according to two main structural processes: 1) folding and 2) faulting.

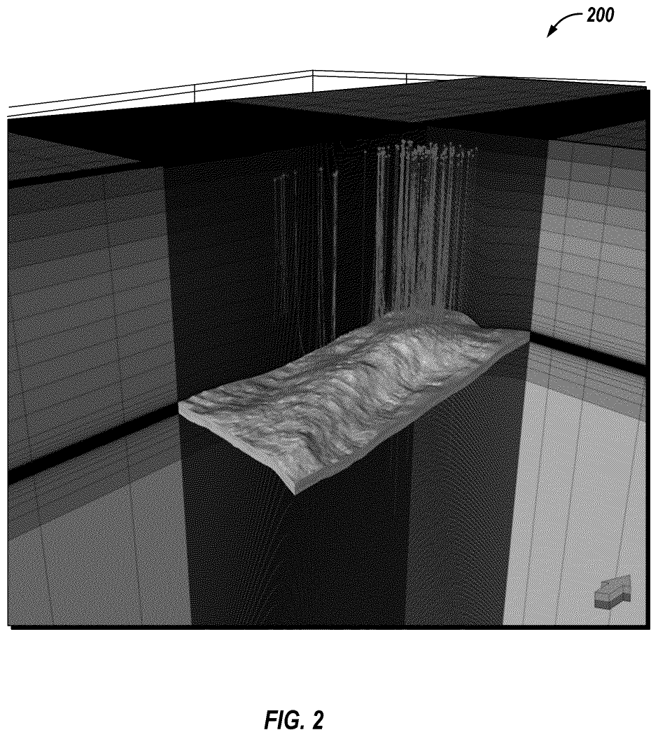

The in-situ stress conditions (block 114) may be modeled to capture all the features for the mechanical properties such as brittleness model, geomechanical facies, in-situ stress rotations and stress magnitude variation along of the field. After modeling, a finite element geomechanical simulation may be performed to construct a 3D mechanical earth model. In some embodiments, the 3D mechanical earth model may be constructed using geomechanical simulation software such as VISAGE™ manufactured by Schlumberger Limited of Houston, Texas, USA. By way of example, FIG. 2 depicts the gridding of a 3D mechanical earth model 200 in accordance with an embodiment of the disclosure.

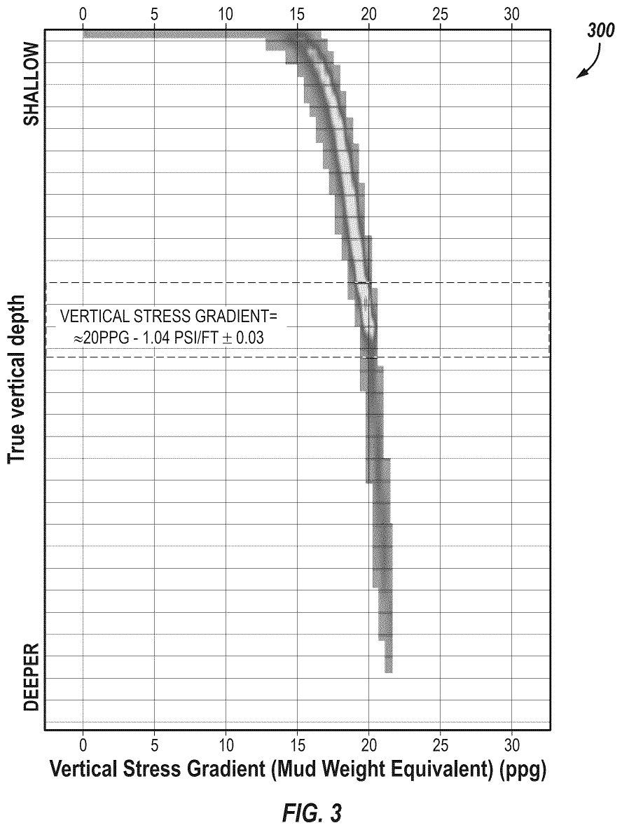

As a part of this determination, the vertical (also referred to as “overburden”) stress may be determined using bulk density logs and a compaction lines technique. By way of example, FIG. 3 depicts a plot 300 of true vertical depth vs. vertical stress gradient (in mud weight equivalent of pounds per gallon (ppg)) that shows a vertical stress calculation using a compaction line and bulk density in accordance with an embodiment of the disclosure. As shown in the example depicted in FIG. 3, the vertical stress gradient is approximately 1.04 pounds per square inch (psi) per foot (ft). In some embodiments, the minimum stress values may be estimated from a micro-fracturing test for determining the fracture closure pressure (FCP); for the example shown in FIG. 3, the minimum stress was calculated to be about 0.72 psi/ft.

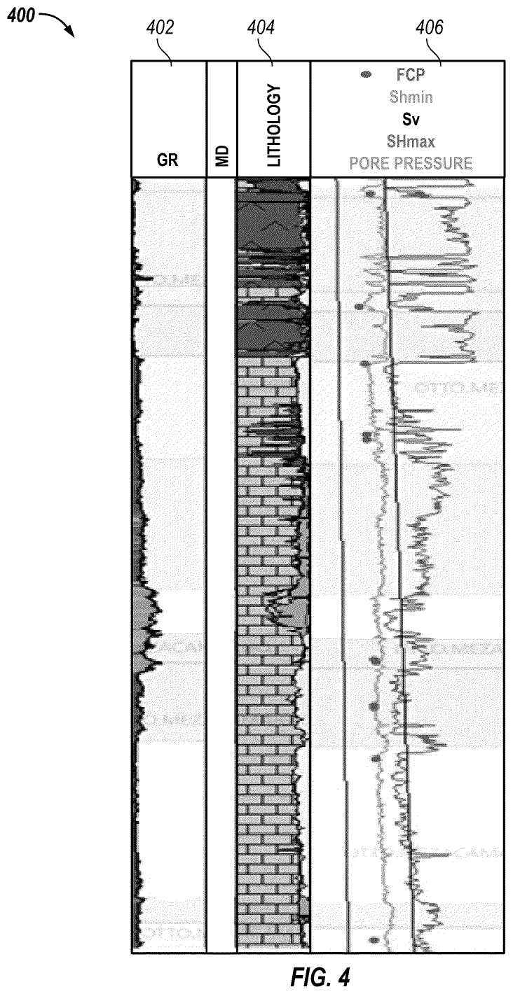

The minimum horizontal stress (Sₕₘᵢₙ) may be calculated from the fracture closure pressure. By way of example, FIG. 4 is a composite log 400 showing gamma ray (Gr) measurements (402), lithology (404), and fracture closure pressure, minimum horizontal stress (Sₕₘᵢₙ), vertical stress (Sᵥ), maximum horizontal stress (Sₕₘₐₓ), and pore pressure (406), in accordance with an embodiment of the disclosure. FIG. 4 depicts a consistent trend for the fracture closure pressure across the example well.

The maximum horizontal stress (S_{Hmax}) may be determined by assuming a strike-slip fault regime such that the maximum horizontal stress (S_{Hmax}) is the largest principal stress (that is, S_{Hmax}>Sᵥ>Sₕₘᵢₙ). The orientation of the maximum horizontal stress may be determined using wellbore failure analysis such as borehole breakouts and drilling-induced tensile fractures interpreted from a borehole image (BHI) log.

A minimum horizontal stress (Sₕₘᵢₙ) and maximum horizontal stress (S_{Hmax}) profile may be determined using a poro-elastic and horizontal-strain stress approach, such that the minimum horizontal stresses and maximum horizontal stresses at each depth depend on the following factors: 1) mechanical properties; 2) pore pressure; and 3) vertical stress (overburden). The pore pressure may be determined from direct measurements using MDT (Modular Formation Dynamics) and Bottom Hole Static Pressure (BHSP) as known in the art. The maximum horizontal stress (S_{Hmax}) may also be constrained by using wellbore stability model and drilling events (for example, mud lost circulation, stuck pipes, in-flow, and tight hole).

As shown in FIG. 1, the process 100 may including 3D fracture modeling (block 104). The generated 3D fracture model may include a Discrete Fracture Network (DFN) spatial distribution primarily constrained by geomechanical and tectonic drivers. The fracture parameters used to construct the network may be length, orientation, aspect ratio (length/height), aperture, and fracture permeability. In some embodiments, the 3D fracture model may be constructed according to the techniques described in U.S. Pat. No. 10,607,043, issued Mar. 31, 2020, and titled “SUBSURFACE RESERVOIR MODEL WITH 3D NATURAL FRACTURES PREDICTION,” a copy of which is incorporated by reference in its entirety.

As shown in FIG. 1, the process 100 may include a 3D critical stress analysis (block 116). The main fluid flow pathways may be discriminated from the 3D discrete fracture network (DFN) resulting from geomechanics and natural fracture prediction (NFP) modeling. The critically stressed fractures and fracture apertures estimation may be performed according to the techniques described in U.S. Publication No. 2023/0084141 A1, published Mar. 16, 2023, and titled “IDENTIFYING FLUID FLOW PATHS IN NATURALLY FRACTURED RESERVOIRS,” a copy of which is incorporated by reference in its entirety.

From the different fracture sets existing within the reservoir, only certain fractures will be optimally oriented under “in situ stress” for shearing and reactivation, and are thus hydraulically more conductive. Fracture aperture computed using a microresistivity technique confirms that fractures closer to failure by shear stress exhibit larger apertures and therefore, they are expected to have higher permeability. A discretized 3D fracture network may thus be produced that only contains fractures representing main fluid pathways in the reservoir.

The 3D critical stress analysis may include use of shear and normal stiffness stress for critically stressed fractures and fracture apertures determination. In terms of stress tensor components σ_{i,j} the normal stress may be defined as the product of stress vector multiplied by normal unit vector σₙ=T⁽ⁿ⁾. n and the magnitude of the shear stress (τₙ) component as defined in Equation 1:

$${τ}_{n} = \sqrt{{( {T}^{( n )} )}^{2} - {σ}_{n}} \qquad ( 1 )$$

A fluid flow path (that is, a critically stressed fracture) may be determined from shear stress and normal effective stress as shown in Equation 2:

$$Fluid flow path = ( τ - {σ}_{n} * Tan ( φ ) ) \geq 0 \qquad ( 2 )$$

In some embodiments, fluid flow paths for a fracture network in a rock matrix may be identified by using determined apertures combined with the normal effective stress and shear stress. The largest aperture corresponds to the greatest distance between the points and the failure Mohr Coulomb line (that is, the friction angle for non-intact rock). In some embodiments, apertures may be determined from microresistivity logs calibrated microresistivity arrays, the fracture dataset, shallow resistivity, and drilling mud resistivity. The fracture aperture determination may be performed using Equation 3:

$$W = {cAR}_{m}^{b} {R}_{xo}^{1 - b} \qquad ( 3 )$$

where W is the fracture width (that is, aperture), Rₓₒ is the flushed zone resistivity, Rₘ is the mud resistivity, and A is the excess current flowing into the rock matrix through the conductive media due to the presence of the fracture. The excess current is a function of the fracture width and may be determined from statistical and geometrical analysis of the anomaly it creates as compared to background conductivity. For example, the excess current may be determined by dividing by voltage and integrating along a line perpendicular to the fracture trace. The term c is a constant and b is numerically obtained tool-specific parameter (that is, specific to the resistivity tools). As will be appreciated, a greater fracture aperture (W) indicates a more open fracture that is likely to flow hydrocarbons or other fluids, and a lesser fracture aperture indicates a fracture that will likely have reduced or low flow to hydrocarbons or other fluids.

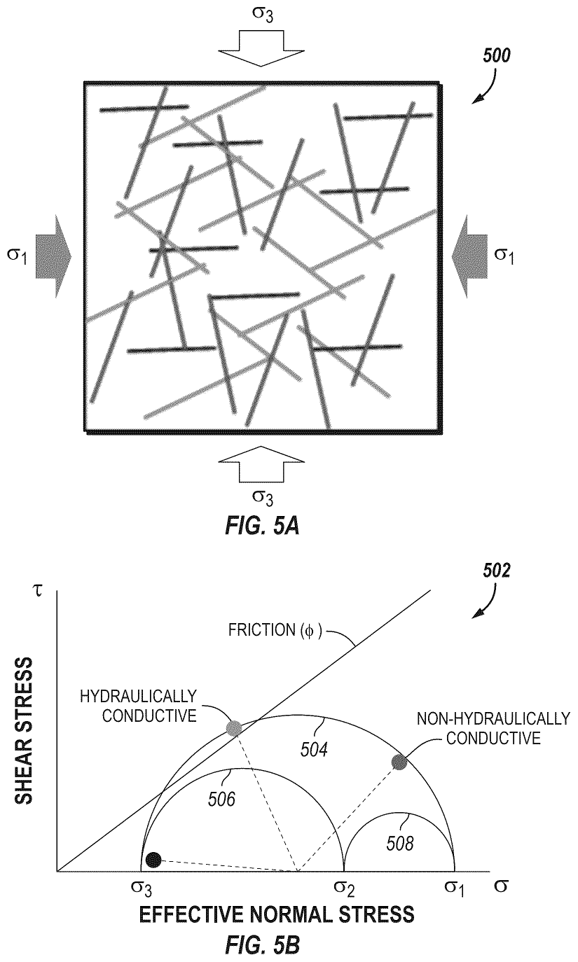

As will be appreciated, critical stress depends on the stress magnitude and the orientation of the fracture plane with respect to the in-situ stress orientation. The stress orientation affects the normal and shear stresses acting in the fracture plane. When normal and shear stress exceed the friction angle (for non-intact rock), the shearing may produce dilation that keeps the fracture hydraulically open. Fractures in this state may be referred to as “reactivated,” “critically stressed,” or as a “fluid flow path.” FIG. 5A is a diagram 500 illustrating fluid flow paths for hydraulically conductive and non-hydraulically conductive fractures using normal stresses (σ₁ and σ₃) in accordance with an embodiment of the disclosure. FIG. 5B is a plot 502 of shear stress vs normal stress and coefficient of friction in accordance with an embodiment of the disclosure. FIG. 5B illustrates “Mohr circles” 504, 506, and 508, as is known in the art.

Shear failure may be caused by two perpendicular stresses acting on the same plane, and is defined in conjunction with a Mohr circle by the following equation expressing stress conditions shown schematically in FIG. 5B:

$$σ {1}^{′} \geq C 0 + σ {3}^{′} tan 2 β \qquad ( 4 )$$

Where C0 is the unconfined compressive strength, σ1′ is the maximum effective stress, σ3′ is the minimum effective stress, and β is the angle between the normal stress and the maximum effective stress σ1′, such is β is determined as follows:

$$β = 45 ° + \frac{Φ}{2} \qquad ( 5 )$$

Where ϕ is the friction angle.

If the maximum effective stress σ1′ is exceeded, then the conditions for shear failure are satisfied.

The results of the critical stress analysis is a discretized 3D fracture network only including fractures that represent the main fluid pathways in the reservoir.

As shown in FIG. 1, the fracture modeling (block 104) of the process 100 also includes determining a fracture density index (block 118). The fracture density index represents natural fractures as a continuous property, accounting for the shape, geometry, and intensity of the natural fractures within a 3D grid-block model In some embodiments, the fracture density index is determined according to the techniques described in U.S. Publication No. 2023/0313649-A1, published Oct. 5, 2023, and titled “SYSTEM AND METHOD TO DEVELOP NATURALLY FRACTURED HYDROCARBON RESERVOIRS USING A FRACTURE DENSITY INDEX,” a copy of which is incorporated by reference in its entirety.

The fracture density index (FDI) represents critical stress fluid pathways in the region of interest. The fracture density index (FDI) determination may include converting the discrete fracture network (into two dimensional (2D) lines to compute a continuous fracture density property, such as described in U.S. Pat. No. 10,607,043, mentioned supra and incorporated by reference in its entirety. For example, various geographic information systems (GIS) geoprocessing software may have tools for computing line density. In some embodiments, the conversion of a 3D discrete fracture network to 2D lines may be performed by ArcGIS available from Environmental Systems Research Institute (Ersi), California, USA. In such embodiments, a raster map representing fracture density per area may be generated.

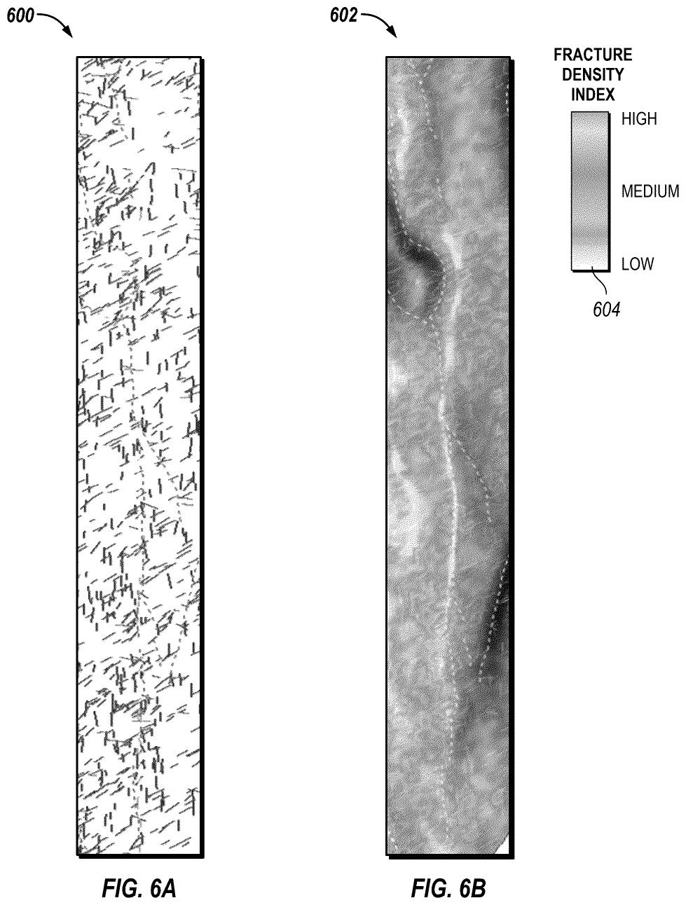

By way of example, FIG. 6A depicts a 2D fracture network 600 illustrating main fluid pathways in an area in accordance with an embodiment of the disclosure. FIG. 6B depicts a line density raster map 602 computed from the 2D fracture network of FIG. 6A in accordance with an embodiment of the disclosure. FIG. 6B also includes a legend 604 that indicates the fracture density index (FDI) according to color-coded values on a continuum from high to medium to low.

As shown in FIG. 1, the process 100 includes performing a static calibration (block 106). The stress regime predicted for the 3D grid model may be used to apply the Coulomb failure criteria for the fracture planes, resulting in the differentiation of hydraulically conductive fractures from non-hydraulically conductive fractures based on their optimal orientation with respect to the current in-situ stress. As will be appreciated, non-permeable fractures are those outside the critically stressed orientation domain.

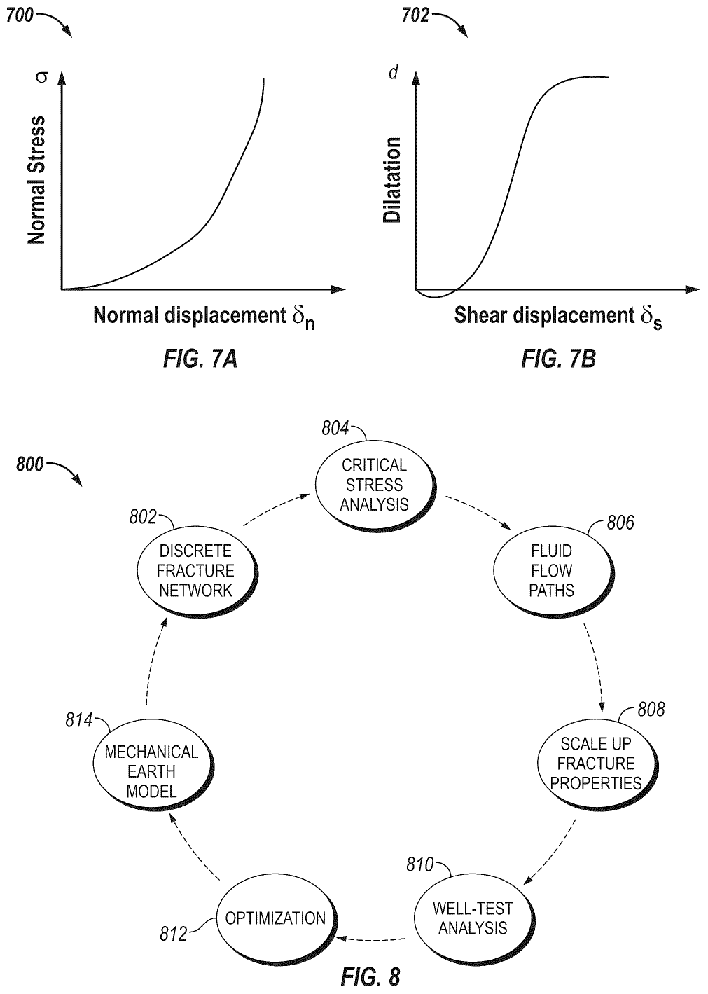

The fracture aperture may be based on normal closure and shearing dilatation. For example, FIG. 7A depicts a graph 700 of normal stress v. normal displacement (on), and FIG. 7B depicts a graph 702 of dilation vs shear displacement (on), in accordance with an embodiment of the disclosure. As only the near-critically-oriented fractures can dilate, shear dilation occurs only partially, while the other fractures are still without dilation. The stress-dependent permeability for fractures that incorporates the effects of both normal closure and shear dilation may be modeled according to the techniques described in Ki-Bok Min et al., (2004), “Stress-dependent permeability of fractured rock masses: a numerical study,” International Journal of Rock Mechanics and Mining Sciences, Volume 41, Issue 7, Pages 1191-127.

The equivalent aperture of normal closure and shear dilation may be formulated based on the following empirical equation:

$$Permeability in fracture rock masses \approx Permability from normal closure + Permeability from shear dilation \qquad ( 6 )$$

The static calibration (block 106) may include determining a flow capacity for fracture and matrix permeability (block 120). To determine total flow capacity, the equivalent permeability for the three components (that is, rock matrix, natural fractures, and structure paleo dissolution (SPD) spaces) may be determined according to the hierarchy described in U.S. Publication No. 2020/0095858-A1, published Mar. 26, 2020, and titled “MODELING RESERVOIR PERMEABILITY THROUGH ESTIMATING NATURAL FRACTURE DISTRIBUTION AND PROPERTIES,” a copy of which is incorporated by reference in its entirety, in which the fractures have the major impact for the fluid flow movement, followed by structural paleo dissolutions (SPD), and lastly rock matrix. Using this hierarchy, the flow capacity may be calculated for each component and optimized using reservoir dynamic response, as shown in the following Equation:

$$Total Flow Capacity from Well test ( K {H}_{PTA )} \approx Flow Capacity for Matrix ( K {H}_{Facimage} ) + Flow Capacity for fracture ( K {H}_{Frac\_simulate )} + Flow Capacity for S P D ( K {H}_{SPD )} \qquad ( 7 )$$

From the previous steps of the process 100, the discrete fracture network is upscaled from the three-dimensional (3D) object planes space to the geocellular gridded model. This process generates fracture porosity distribution, transfer functions coefficient and fracture permeability. The effective permeability tensor (Kᵢ,Kⱼ,Kₖ) is used to calculate the flow capacity from the fracture model (KH_{Frac-simulate}), then multiple realizations are constructed based on the workflow 800 depicted in FIG. 8. As shown in FIG. 8, the workflow 800 depicts multiple fracture realizations that may be used for validations and calibrations in accordance with an embodiment of the disclosure. The impact of critically stressed aperture and permeability on fluid flow may be quantified using equivalent permeability, which considers fracture, HPS, and matrix flow and the interaction between these three factors. For example, FIG. 8 depicts the following determinations: discrete fracture network 802, critical stress analysis 804, fluid flow paths 806, the scale up of fracture properties 808, well test analysis 810, optimization 812, and a mechanical earth model 814. As discussed supra, the realizations may be determined according to the techniques described in U.S. Publication No. 2020/0095858-A1, incorporated by reference in its entirety.

Using the determined aperture distribution, a standard cubic law function may be used as an equation for the stress-dependent permeability to incorporate the effects of both normal closure and shear dilation of fractures through the aperture distribution based on critical stress.

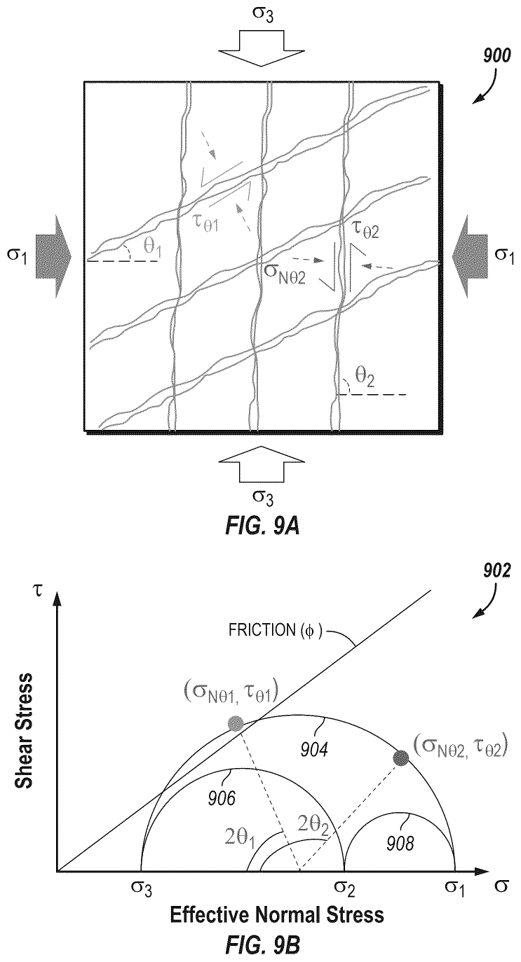

FIGS. 9A and 9B depict nonlinear behavior for fracture apertures under effective normal stress. FIG. 9A depicts a stress diagram 900 using normal stresses (σ₁ and σ₃) in accordance with an embodiment of the disclosure. FIG. 9B is a plot 902 of shear stress vs normal stress and coefficient of friction and depicts a Mohr diagram in accordance with an embodiment of the disclosure. FIG. 9B illustrates “Mohr circles” 904, 906, and 908, as is known in the art.

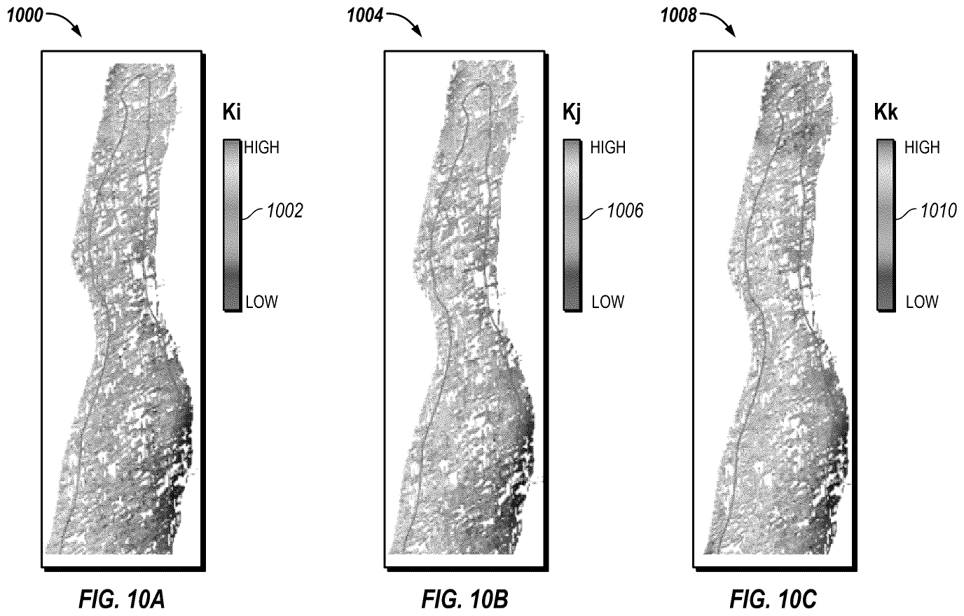

Determining fracture network properties may using a scale-up process to transform the fluid-flow planes into 3D grid block properties (for example, porosity and permeability) that generate fracture tensor permeability, porosity and sigma or shape factor. By way of example, FIGS. 10A-10C depict fracture porosity and effective tensor permeability calculated from a scale up probes in accordance with an embodiment of the disclosure. FIG. 10A is a map 1000 the Ki component of the effective tensor permeability according to legend 1002, FIG. 10B is a map 1004 the Ki component of the effective tensor permeability according to legend 1006, and FIG. 10C is a map 1008 the Ki component of the effective tensor permeability according to legend 1010. In some embodiments, the conversion from discrete fracture planes to a grid model may be performed using Oda's method. In some embodiments, the conversion from discrete fracture plans to a grid model may be performed according to the techniques described in U.S. Publication No. 2020/0095858-A1 mentioned supra and incorporated by reference in its entirety. In such embodiments, the upscaling process may be performed using a software package such as Petrel™, Fracflow®, or other suitable upscaling methodology.

Additionally, the static calibration (block 106) may include the determination of productivity ratios (block 122). Embodiments of the disclosure include performing and obtaining results from well tests, such a pressure transient analysis (PTA), that may be used in the techniques described in the disclosure.

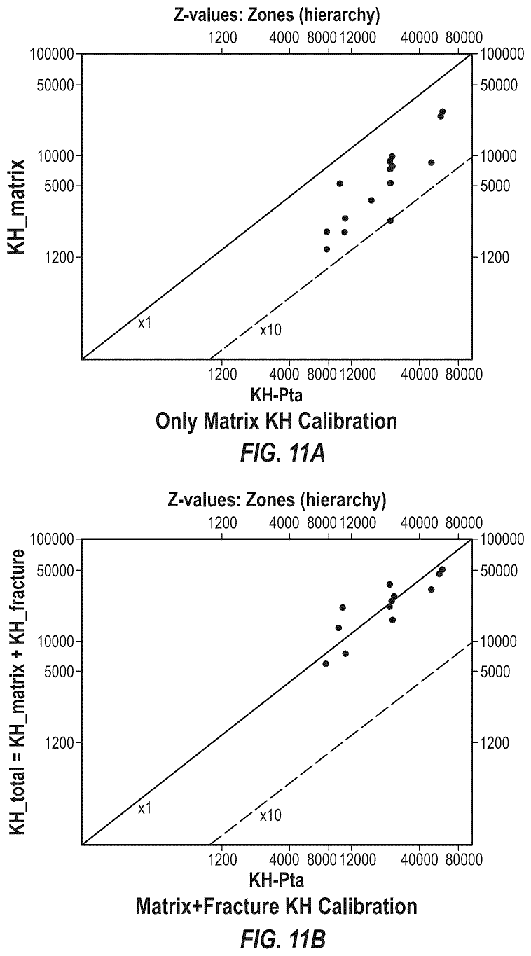

The productivity ratios may be calculated based on the flow capacity observed from a well test (that is, a pressure transient analysis (PTA)) and the flow capacity calculated from the permeability model. Additionally, using the fracture permeability tensor, an equivalent flow capacity KH (the product of formation permeability, k, and producing formation thickness, h) representing the natural fractures may be generated in order to create the ratio to be applied on the matrix permeability, as follows:

$$Ratio = \frac{K {H}_{pta}}{K {H}_{facimage}} \qquad ( 8 )$$

where a KHₚₜₐ is the flow capacity from PTA and a KH_{facimage} (also referred to as KHₘₐₜᵣᵢₓ) is the flow capacity from the matrix model. By way of example, FIG. 11A depicts a plot 1100 of KHₘₐₜᵣᵢₓ vs a KHₚₜₐ using only a matrix calibration, and FIG. 11B depicts a plot 1102 of KHₜₒₜₐₗ (KHₘₐₜᵣᵢₓ+KH_{fracture}) vs. KHₚₜₐ using only a matrix +fracture KH calibration, in accordance with an embodiment of the disclosure.

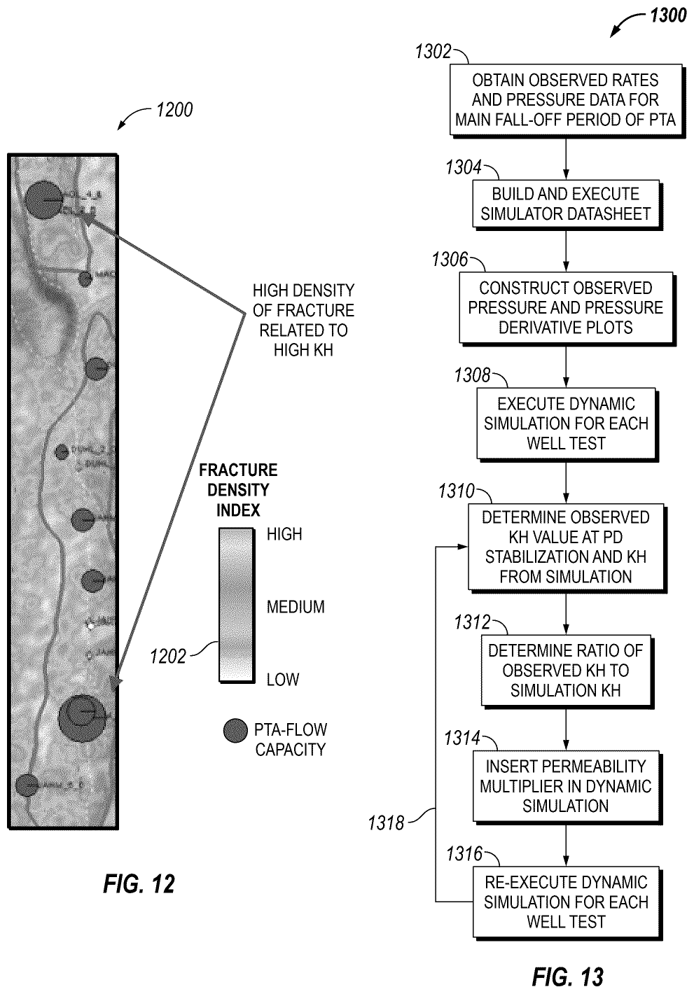

FIG. 12 depicts PTA flow capacity (KHₚₜₐ) overlaid on a fracture density index map 1200 in accordance with an embodiment of the disclosure. FIG. 12 includes a color legend 1202 corresponding to the continuum of high to medium to low fracture density index, with the flow capacity represented as red circles on the map 1200. The highest fracture density indices show a relationship to the greater KHₚₜₐ (largest red circles).

As shown in FIG. 1, the process 100 includes performing a dynamic calibration (block 108) that includes dynamic calibration of the fracture density index (FDI). FIG. 13 depicts a process 1300 for the dynamic calibration in accordance with an embodiment of the disclosure. The dynamic calibration may be performed using a “single porosity/single permeability” (SPSP) grid and a rank match pressure derivative (RMPD) tool to evaluate the fracture density index (FDI) as an enhancer for matrix permeability.

Initially, observed rates and pressure data (that is, bottom hole pressure (BHP) data) for the main fall-off period of the pressure transient analysis (PTA) are obtained (block 1302). A simulator data set may be built and executed for each well test (block 1304). Next, observed pressure and pressure derivative plots (log-log) are constructed from the input data (block 1306). A dynamic simulation may then be executed for each well test (block 1308) by placing a local grid refinement around the well. An observed flow capacity KH value at pressure derivative (PD) stabilization and a flow capacity KH from the simulation are determined (block 1310).

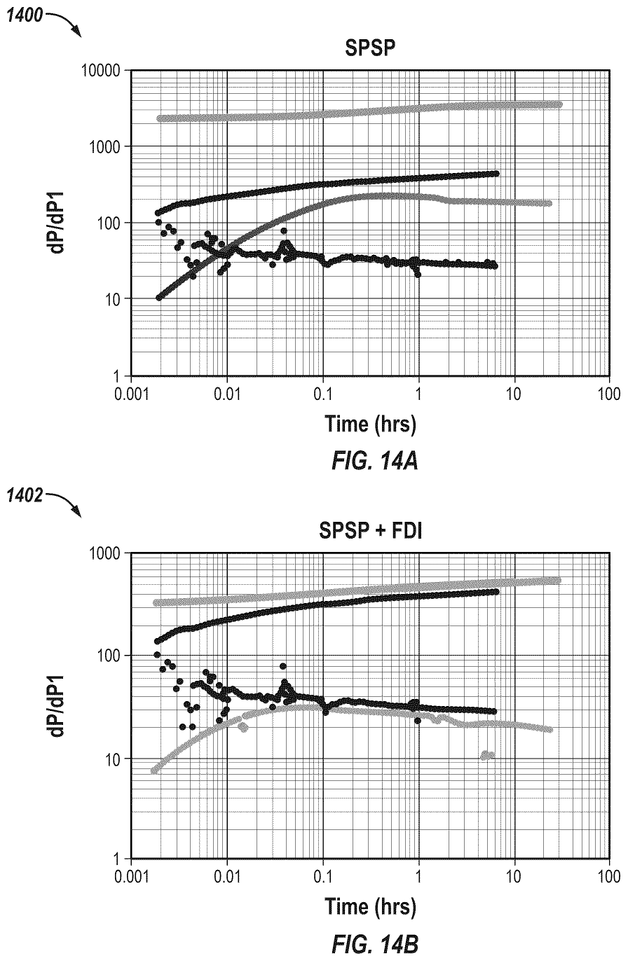

The ratio of the observed KH to the simulation KH is determined (block 1312). Using this ratio (that is, the mismatch between the observed KH and the simulation KH), a permeability multiplier is inserted in the dynamic simulation (block 1314). The permeability multiplier value that best fit the KH (observed vs simulated) for each of the well tests may be used to affect the permeability logs at each well, which are then used to repopulate the permeability across the model. The dynamic simulation for each well test is then re-executed (block 1316) with this process continuing iteratively (arrow 1318). By way of example, FIGS. 14A and 14B show a comparison of KH calibration results for SPSP and SPSP+FDI in accordance with an embodiment of the disclosure. FIG. 14A is a plot 1400 of SPSP simulated derivative pressure vs. time in accordance with an embodiment of the disclosure. FIG. 14B is a plot 1402 of SPSP+FDI simulated derivative pressure vs. time in accordance with an embodiment of the disclosure.

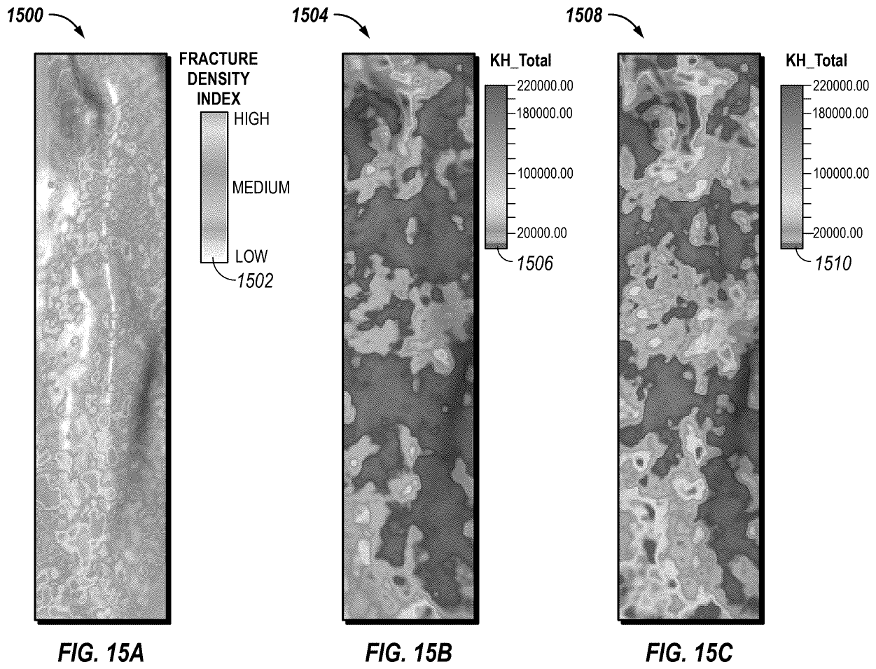

Next, as shown in FIG. 1, the process 100 may include enhancing matrix permeability (block 126). After the dynamic calibration, the fracture density index can be used as matrix enhancer or multiplier for the matrix permeability, preserving the geological and dynamic consistence for the natural fractures and matrix media. FIGS. 15A-15C depict this step of the process 100. FIG. 15A depicts a fracture density index map 1500 with the fracture density index values identified by the color legend 1502. FIG. 15B depicts a KH value map 1504 with the KH value identified by the color legend 1506. FIG. 15C depicts a KH value map 1508 after the application of the fracture density index as a matrix permeability enhancer to the KH value map 1504 of FIG. 15B, with the KH values indicated by color legend 1510.

The process 100 may also include history matching (block 110) of the flow rate and BHP. After the calibration of a model with KH with the modified permeability, the flow rate and BHP may be history matched at shut-in for all well tests. The history matching may be performed by making sensitives with a well's productivity and injectivity indices (PI/II) or skin until an acceptable match is accomplished (for example, when a match is within a specific threshold value).

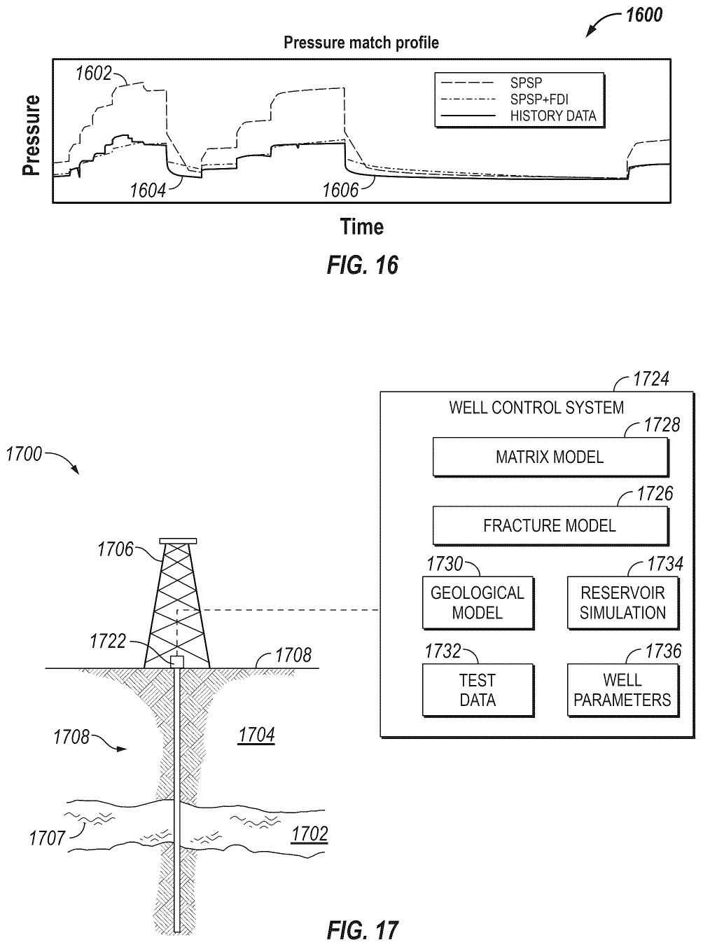

After performing the sensitivity analysis on the parameters affecting the well deliverability, the history match results (block 128) may be evaluated. For example, a comparison between the observed BHP and the simulated BHP may be performed for both the SPSP and SPSP+FDI scenarios to show the improvement the FDI has on the BHP match for the SPSP-enhanced permeability scenario. For example, FIG. 16 is a plot 1600 of pressure vs. time showing the pressure match profile for these scenarios. As shown in FIG. 16, line 1602 is the SPSP-only pressure, line 1604 is the SPSP+FDI pressure, and line 1606 is the historical pressure data. As shown by these lines, the SPSP+FSI pressure line 1604 more closely matches the historical data line 1606.

FIG. 17 is a diagram that illustrates a well environment 1700 for implementing embodiments of the disclosure. In the illustrated embodiment, the well environment 1700 includes a reservoir (“reservoir”) 1702 located in a subsurface formation (“formation”) 1704 and a well system (“well”) 1706.

The formation 1704 may include a porous or fractured rock formation that resides beneath the earth's surface (or “surface”) 1708. The reservoir 1702 may be a hydrocarbon reservoir defined by a portion of the formation 1704 that contains (or that is at least determined or expected to contain) a subsurface pool of hydrocarbons, such as oil and gas. The formation 1704 and the reservoir 1702 may each include layers of rock having varying characteristics, such as varying degrees of permeability, porosity and fluid saturation. The formation 1704 may include natural fractures 1707 (e.g., fractures created by naturally occurring stress and formation movement).

In the illustrated embodiment, the well 1706 includes a wellbore 1720, a drilling or production system 1722, and a well control system (“control system”) 1724. The wellbore 1720 is defined by a bored hole that extends from the surface 1708 into a target zone of the formation 1704, such as the reservoir 1702. The wellbore 1720 may be created, for example, by a drill bit of a drilling system of the well 1706 boring through the formation 1704 and the reservoir 1702. An upper end of the wellbore 1720 (e.g., located at or near the surface 1708) may be referred to as the “up-hole” end of the wellbore 1720. A lower end of the wellbore 1720 (e.g., terminating in the formation 1704) may be referred to as the “down-hole” end of the wellbore 1720. In the case of the well 1706 being operated as a production well, the well 1706 may be a hydrocarbon production well that is operable to facilitate the extraction of hydrocarbons (or “production”) from the reservoir 1702. In the case of the well 1706 being operated as an injection well, the well 1706 may be a water or gas injection well that is operable to facilitate the injection of water or gas into the formation 1704 (for hydraulic fracturing stimulation or “fracking”) to generate induced fractures.

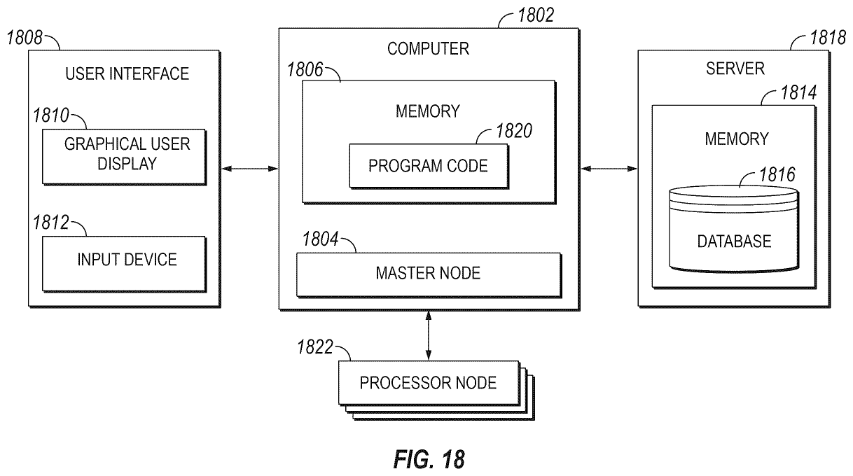

In some embodiments, the well control system 1724 is operable to control various operations of the well 1706, such as well drilling operations, well completion operations, well production operations, or well or formation remediation operations. For example, the well control system 1724 may include a well system memory and a well system processor that are capable of performing the various processing and control operations of the well control system 1724 described here. In some embodiments, the well control system 1724 includes a computer system that is the same as or similar to that of data processing system 1800 described with regard to FIG. 18.

In some embodiments, the well control system 1724 is operable to obtain, determine, or both various aspects of embodiments of the disclosure. This may include, for example, the well control system 1724 performing the following operations: (1) determining a natural fracture model 1726 of the hydrocarbon reservoir 1702; (2) determining a matrix model 1728 of the hydrocarbon reservoir for generating a matrix permeability and matrix flow capacity; (2) determining a geological model 1730 of the hydrocarbon reservoir 1702 for generating a modeled permeability and flow capacity for the well 1706 (e.g., a modeled flow capacity that is dependent on the fracture modeling parameters); (3) determining an observed well flow capacity for the well (e.g., based on observed well test data 1732, such as pressure transient analysis (PTA) data).

In some embodiments, the well control system 1724 determines well parameters 1736 for the well 1706 based on a reservoir simulation 1740 that incorporates the enhanced matrix permeability according to embodiments of the disclosure, and the well 1706 is developed in accordance with the well parameters 1732. The well parameters 1736 may include, for example, a well location and a wellbore trajectory. In such an instance, operating the well 1706 may include the well control system 1724 (or another operator) controlling a drilling system to drill the wellbore 1720 of the well 1706 at the location and trajectory. As a further example, the well parameters 1736 may include a production pressure or production rate, and operating the well 1706 may include the well control system 1724 (or another operator) controlling the production system 1722 of the well 1706 to operate the well 1706 at the production pressure or production rate.

FIG. 18 depicts a data processing system 1800 that includes a computer 1802 having a master node processor 1804 and memory 1806 coupled to the processor 1804 to store operating instructions, control information and database records therein in accordance with an embodiment of the disclosure. The data processing system 1800 may be a multicore processor with nodes such as those from Intel Corporation or Advanced Micro Devices (AMD), or an HPC Linux cluster computer. The data processing system 1800 may also be a mainframe computer of any conventional type of suitable processing capacity such as those available from International Business Machines (IBM) of Armonk, N.Y., or other source. The data processing system 1800 may in cases also be a computer of any conventional type of suitable processing capacity, such as a personal computer, laptop computer, or any other suitable processing apparatus. It should thus be understood that a number of commercially available data processing systems and types of computers may be used for this purpose.

The computer 1802 is accessible to operators or users through user interface 1808 and are available for displaying output data or records of processing results obtained according to the present disclosure with an output graphic user display 1810. The output display 1810 includes components such as a printer and an output display screen capable of providing printed output information or visible displays in the form of graphs, data sheets, graphical images, data plots and the like as output records or images.

The user interface 1808 of computer 1802 also includes a suitable user input device or input/output control unit 1812 to provide a user access to control or access information and database records and operate the computer 1802. Data processing system 1800 further includes a database of data stored in computer memory, which may be internal memory 1806, or an external, networked, or non-networked memory as indicated at 1814 in an associated database 1816 in a server 1818.

The data processing system 1800 includes executable code 1820 stored in non-transitory memory 1806 of the computer 1802. The executable code 1820 according to the present disclosure is in the form of computer operable instructions causing the data processor 1804 to determine a mechanical earth model, perform fracture modeling, perform static calibration, perform dynamic calibration, and perform history matching as described in the disclosure. Moreover, the computer operable instructions of the executable code 1820 may include performing a reservoir simulation using a single media representing natural fractures according to the techniques described herein.

It should be noted that executable code 1820 may be in the form of microcode, programs, routines, or symbolic computer operable languages capable of providing a specific set of ordered operations controlling the functioning of the data processing system 1800 and direct its operation. The instructions of executable code 1820 may be stored in memory 1806 of the data processing system 1800, or on computer diskette, magnetic tape, conventional hard disk drive, electronic read-only memory, optical storage device, or other appropriate data storage device having a non-transitory computer readable storage medium stored thereon. Executable code 1820 may also be contained on a data storage device such as server 1818 as a non-transitory computer readable storage medium, as shown.

The data processing system 1800 may be include a single CPU, or a computer cluster as shown in FIG. 18, including computer memory and other hardware to make it possible to manipulate data and obtain output data from input data. A cluster is a collection of computers, referred to as nodes, connected via a network. A cluster may have one or two head nodes or master nodes 1804 used to synchronize the activities of the other nodes, referred to as processing nodes 1822. The processing nodes 1822 each execute the same computer program and work independently on different segments of the grid which represents the reservoir.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for developing a hydrocarbon reservoir, the method comprising:
forming, using a mechanical earth model, a fracture network model to identify the presence and extent of natural fractures at locations in the subsurface hydrocarbon reservoir, wherein the mechanical earth model incorporates the principal stress;
determining, using the discrete fracture network, a fracture density index (FDI), wherein determining the fracture density index (FDI) comprises generating a raster map from the discrete fracture network, the raster map representing a fracture density per area;
modifying the fracture density index (FDI) based on a flow capacity response; and
calibrating the modified fracture density index (FDI) using a bottom hole pressure (BHP) and a BHP rate; and
applying the calibrated modified fracture density index (FDI) to a single media matrix permeability for the reservoir to determine an improved matrix permeability.

2. The method of claim 1, wherein the flow capacity response comprises a flow capacity from a pressure transient analysis (PTA).

3. The method of claim 1, wherein the flow capacity response comprises a flow capacity from a matrix permeability model.

4. The method of claim 1, wherein calibrating the modified fracture density index (FDI) using a bottom hole pressure (BHP) and a BHP rate comprises using a pressure transient analysis simulation to determine a permeability multiplier.

5. The method of claim 1, comprising performing a history match between for the bottom hole pressure (BHP).

6. The method of claim 1, wherein the modified fracture density index (FDI) comprises an effective permeability tensor.

7. The method of claim 1, comprising determining a location for a well to access the hydrocarbon reservoir using the improved matrix permeability.

8. The method of claim 7, comprising drilling the well at the location to access the hydrocarbon reservoir.

9. A non-transitory computer-readable storage medium having executable code stored thereon for developing a hydrocarbon reservoir, the executable code comprising a set of instructions that causes a processor to perform operations comprising:
forming, using a mechanical earth model, a fracture network model to identify the presence and extent of natural fractures at locations in the subsurface hydrocarbon reservoir, wherein the mechanical earth model incorporates the principal stress;
determining, using the discrete fracture network, a fracture density index (FDI), wherein determining the fracture density index (FDI) comprises generating a raster map from the discrete fracture network, the raster map representing a fracture density per area;
modifying the fracture density index (FDI) based on a flow capacity response; and
calibrating the modified fracture density index (FDI) using a bottom hole pressure (BHP) and a BHP rate; and
applying the calibrated modified fracture density index (FDI) to a single media matrix permeability for the reservoir to determine an improved matrix permeability.

10. The non-transitory computer-readable storage medium of claim 9, wherein the flow capacity response comprises a flow capacity from a pressure transient analysis (PTA).

11. The non-transitory computer-readable storage medium of claim 9, wherein the flow capacity response comprises a flow capacity from a matrix permeability model.

12. The non-transitory computer-readable storage medium of claim 9, wherein calibrating the modified fracture density index (FDI) using a bottom hole pressure (BHP) and a BHP rate comprises using a pressure transient analysis simulation to determine a permeability multiplier.

13. The non-transitory computer-readable storage medium of claim 9, comprising performing a history match between for the bottom hole pressure (BHP).

14. The non-transitory computer-readable storage medium of claim 9, wherein the modified fracture density index (FDI) comprises an effective permeability tensor.

15. The non-transitory computer-readable storage medium of claim 9, comprising determining a location for a well to access the hydrocarbon reservoir using the improved matrix permeability.

16. The non-transitory computer-readable storage medium of claim 15, comprising controlling a drilling operation to drill the well at the location to access the hydrocarbon reservoir.

17. A system for developing a hydrocarbon reservoir, comprising:
a processor;
a non-transitory computer-readable memory accessible by the processor and having executable code stored thereon, the executable code comprising a set of instructions that causes a processor to perform operations comprising:
forming, using a mechanical earth model, a fracture network model to identify the presence and extent of natural fractures at locations in the subsurface hydrocarbon reservoir, wherein the mechanical earth model incorporates the principal stress;
determining, using the discrete fracture network, a fracture density index (FDI), wherein determining the fracture density index (FDI) comprises generating a raster map from the discrete fracture network, the raster map representing a fracture density per area;
modifying the fracture density index (FDI) based on a flow capacity response; and
calibrating the modified fracture density index (FDI) using a bottom hole pressure (BHP) and a BHP rate; and
applying the calibrated modified fracture density index (FDI) to a single media matrix permeability for the reservoir to determine an improved matrix permeability.

18. The system of claim 17, wherein the flow capacity response comprises a flow capacity from a pressure transient analysis (PTA).

19. The system of claim 17, wherein the flow capacity response comprises a flow capacity from a matrix permeability model.

20. The system of claim 17, wherein calibrating the modified fracture density index (FDI) using a bottom hole pressure (BHP) and a BHP rate comprises using a pressure transient analysis simulation to determine a permeability multiplier.

21. The system of claim 17, comprising performing a history match between for the bottom hole pressure (BHP).

22. The system of claim 17, wherein the modified fracture density index (FDI) comprises an effective permeability tensor.

23. The system of claim 17, comprising determining a location for a well to access the hydrocarbon reservoir using the improved matrix permeability.

24. The system of claim 23, comprising controlling a drilling operation to drill the well at the location to access the hydrocarbon reservoir.
